(19) United States
(12) Patent Application Publication
(10) Pub. No.: US 2026/0326502 A1
(43) Pub. Date: Oct. 22, 2026

(54) ACTUATOR INSTALLATION IN A VEHICLE HEATING, VENTILATION, AND AIR-CONDITIONING SYSTEM (HVAC) DUCT

(71) Applicant: Volvo Truck Corporation, Göteborg (SE)

(72) Inventors: Nicolas BERNE, Heyrieux (FR); Roseline HEUTE, Meyzieu (FR)

(73) Assignee: Volvo Truck Corporation, Göteborg (SE)

(21) Appl. No.: 19/427,155

(22) Filed: Dec. 19, 2025

(51) Int. Cl. B60H 1/00

(52) U.S. Cl. CPC B60H 1/00857; B60H 1/00678

(57) ABSTRACT

A method for replacing a vent actuator in a heating, ventilation, and air-conditioning (HVAC) system of a vehicle is provided. The method includes opening a front lid of the vehicle to access an air inlet of the HVAC system, removing an air filter from the air inlet, and removing the vent actuator through the air inlet. The method further includes installing a replacement vent actuator through the air inlet. The method may include positioning a recirculation flap of the HVAC system in an open position prior to removal of the actuator and reinitializing the HVAC system after installation.

### TECHNICAL FIELD

The disclosure relates generally to heating, ventilation, and air-conditioning (HVAC) systems for vehicles. In particular aspects, the disclosure relates to actuator installation in HVAC ducts for vehicles.

The disclosure can be applied in heavy-duty vehicles, such as trucks, buses, and construction equipment. Although the invention will be described with respect to a particular vehicle, the invention is not restricted to any particular vehicle.

### BACKGROUND

Modern vehicles are typically equipped with heating, ventilation, and air-conditioning (HVAC) systems that regulate cabin temperature, humidity, and air quality for occupant comfort. A typical HVAC system includes one or more air inlets, filters, ducts, and a series of movable vents or flaps that direct airflow between different zones and modes of operation. Actuators, often electric motors with position sensors, are used to control the movement of these vents or flaps to adjust airflow distribution, temperature mixing, and the balance between outside and recirculated air. In many vehicle configurations, the HVAC assembly is located behind the instrument panel or beneath the windshield cowl, with vent actuators positioned along the air paths within or adjacent to the HVAC housing. These actuators are subject to wear, contamination, or electrical failure over time and may require replacement during the vehicle's service life.

### SUMMARY

Vehicle heating, ventilation, and air-conditioning (HVAC) systems commonly include one or more vent actuators that control movable flaps or doors to regulate airflow between fresh-air and recirculation modes. In many existing vehicle designs, the recirculation vent actuator is located deep within the HVAC housing and can only be accessed from inside the vehicle cabin. Replacing a failed actuator typically requires removal of multiple interior panels, covers, and ducts, which increases repair time and cost. Because vent actuators are relatively inexpensive components, the labor required for replacement can exceed the value of the part itself, leading to inefficiency in aftermarket service operations. Accordingly, there is a need for an HVAC configuration that allows a vent actuator, such as a recirculation vent actuator, to be accessed and replaced more easily, preferably by opening a front lid of the vehicle to access an air inlet, without dismantling interior cabin components.

According to an aspect of the disclosure, a method for replacing a vent actuator in an HVAC system of a vehicle includes: opening a front lid of the vehicle to access an air inlet; removing an air filter from the air inlet; removing the vent actuator through the air inlet; and installing a replacement vent actuator through the air inlet from.

In some examples, the method includes positioning a flap of the HVAC system in an open position prior to removing the vent actuator. In some examples, the vent actuator is mounted on a rotation shaft of a flap of the HVAC system. In some examples, the flap is a recirculation flap and the vent actuator is a recirculation actuator configured to operate a recirculation flap of the HVAC system, and the method includes rotating, by the recirculation actuator, the rotation shaft to move the recirculation flap between a fresh-air position and a recirculation position. In some examples, the method includes receiving, by the vent actuator, an electrical control signal from an HVAC control unit to position the recirculation flap. In some examples, the HVAC control unit generates the control signal in response to a sensor signal indicative of a cabin air quality parameter. In some examples, the recirculation flap is pivotably mounted within the air inlet to selectively block or allow airflow. In some examples, the method includes reinitializing the HVAC system after installation of the replacement vent actuator. In some examples, the replacement vent actuator is installed with a cover, and the cover may be shaped to reduce aerodynamic disturbance of airflow through the air inlet. In some examples, the vent actuator is accessed directly after removal of the air filter without disassembly of interior cabin components.

According to a further aspect of the disclosure, a vehicle HVAC system includes: an air inlet configured to receive outside air into the HVAC system; an air filter removably mounted within the air inlet; a recirculation flap pivotably mounted within the air inlet and rotatable between a fresh-air position and a recirculation position; a recirculation actuator positioned within the air inlet and accessible for removal and installation through the air inlet after removal of the air filter.

In some examples, the recirculation actuator is mounted on a rotation shaft of the recirculation flap. In some examples, the recirculation actuator comprises a motor housing including a drive coupling directly engaged with the rotation shaft of the recirculation flap. In some examples, the drive coupling comprises a keyed or splined interface configured to mate a corresponding portion of the rotation shaft. In some examples, the recirculation actuator is disposed entirely within the air inlet downstream of the air filter. In some examples, the recirculation actuator is secured to the air inlet by at least one fastener extending through a flange portion of an actuator housing or by snap-fit connectors integrally formed on the actuator housing. In some examples, the recirculation actuator includes a cover. In some examples, the cover is shaped to reduce aerodynamic disturbance of airflow through the air inlet. In some examples, the recirculation flap comprises a sealing edge configured to substantially block airflow when the flap is in a closed position.

Additional features and advantages are disclosed in the following description, claims, and drawings, and in part will be readily apparent therefrom to those skilled in the art or recognized by practicing the embodiments as described herein.

### BRIEF DESCRIPTION OF THE DRAWINGS

With reference to the appended drawings, below follows a more detailed description of embodiments of the invention cited as examples.

FIG. 1 is a front perspective view of a vehicle showing the front lid in an open position to provide access to an air inlet of a heating, ventilation, and air-conditioning (HVAC) system.

FIG. 2 is an exploded perspective view of the air inlet, illustrating an air intake grille, an air filter, and an air inlet housing.

FIG. 3 is a partial perspective view of the air inlet showing a recirculation flap in a closed position.

FIG. 4 is a partial perspective view similar to FIG. 3 showing the recirculation flap in an open position and exposing an actuator mounted to a rotation shaft.

FIG. 5 is a schematic sectional view illustrating a mounting interface between the actuator and the air inlet housing, including a mounting flange, sealing gasket, and fasteners.

FIG. 6 is a block diagram of an HVAC control system including a control unit, sensor, and actuator.

FIG. 7 is a flow diagram illustrating a method for replacing the actuator through the air inlet.

### DETAILED DESCRIPTION

The embodiments set forth below represent the necessary information to enable those skilled in the art to practice the embodiments and illustrate the best mode of practicing the embodiments.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

The embodiments described herein relate to heating, ventilation, and air-conditioning (HVAC) systems for vehicles, and more particularly to configurations that allow improved accessibility and serviceability of vent actuators. While the embodiments illustrated and described below focus primarily on a recirculation vent actuator, the concepts disclosed may be applied to other vent actuators within a vehicle HVAC system, including fresh-air, blend, and mode actuators.

In general, the HVAC system of a vehicle includes an air inlet that draws in ambient air, an air filter that removes particulates, and a series of ducts and flaps that control the temperature and distribution of conditioned air to the passenger compartment. Vent actuators are typically positioned to drive the rotation of vent flaps or doors that regulate these airflow paths. In conventional arrangements, many of these actuators are located on the cabin side of the HVAC housing, making them difficult to reach when service or replacement is required.

The embodiments described herein reposition one or more vent actuators so that they are easily accessible from within the HVAC system, for example, by being accessable through the air inlet after removal of the air filter. This configuration allows a technician to remove and replace the actuator without disassembling interior panels or ducts, thereby reducing service time and cost.

Although the following description refers primarily to a truck HVAC system for clarity, it will be understood that the described concepts are equally applicable to other vehicles and HVAC configurations. The relative orientation of components such as “front,” “rear,” “upper,” and “lower” is provided for descriptive convenience only and is not intended to limit the scope of the invention. Additional variations, modifications, and equivalents will be apparent to those skilled in the art based on the teachings set forth herein.

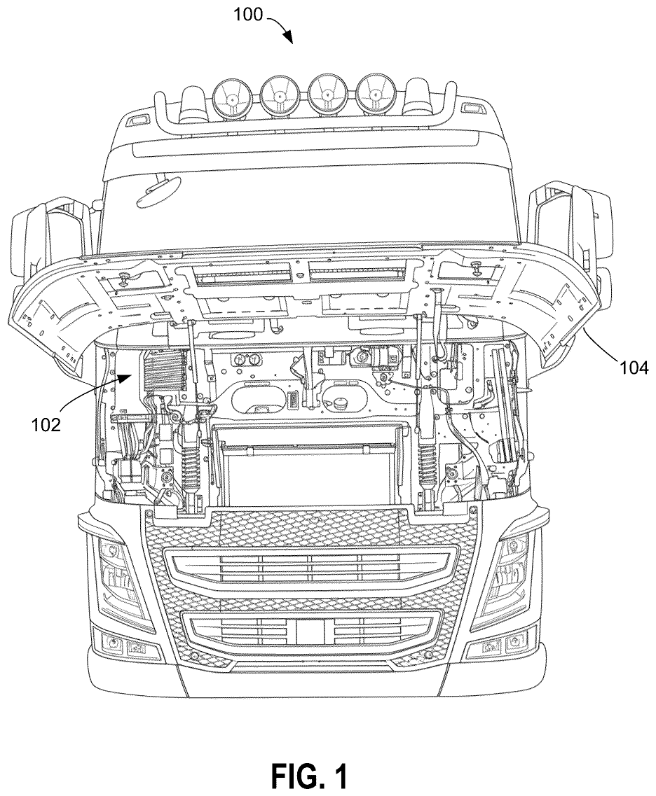

FIG. 1 is a simplified schematic diagram of a vehicle 100 having a front lid 104 in an open position to provide access to components located behind the front panel of the vehicle, in accordance with some embodiments. The vehicle 100 includes an air inlet 102 that forms part of the vehicle's heating, ventilation, and air-conditioning (HVAC) system. The air inlet 102 is configured to receive outside air into the HVAC system for filtration and subsequent delivery to the vehicle cabin.

In the illustrated embodiment, the air inlet 102 is accessible when the front lid 104 is opened, allowing service access to components positioned behind the lid, including one or more vent actuators as described in greater detail below. This arrangement facilitates replacement or maintenance of the vent actuator, without requiring removal of interior cabin panels or other internal HVAC components.

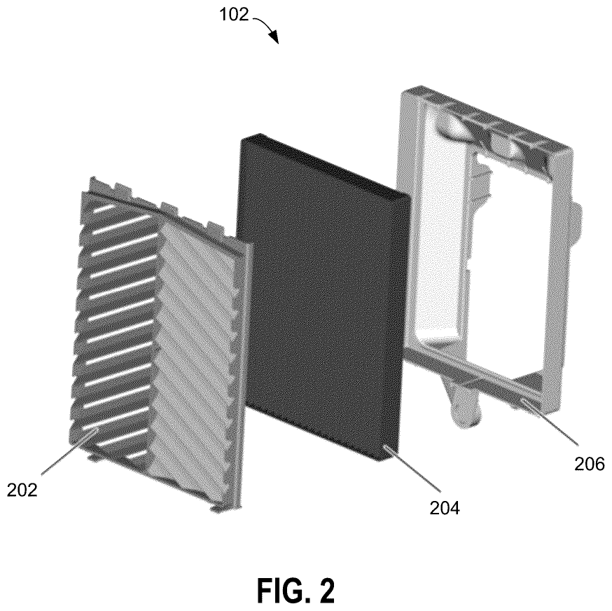

FIG. 2 shows the air inlet 102 of the vehicle HVAC system in greater detail, in accordance with some embodiments. The air inlet 102 includes an air intake grille 202, an air filter 204, and an air inlet housing 206. The air inlet 102 is positioned on the backside of the HVAC system, facing toward the front of the vehicle, and is configured to allow air to flow from the atmosphere into the HVAC system. The air intake grille 202 is disposed at the outermost position of the air inlet 102 and includes a series of angled vanes or openings that direct incoming airflow and prevent large debris from entering the system. The air filter 204 is located downstream of the air intake grille 202 and functions to trap dust, pollen, and other airborne particles before the air enters the HVAC system. The air inlet housing 206 supports the grille 202 and the air filter 204 and defines an airflow passage leading into the HVAC system.

In the illustrated embodiment, removal of the air filter 204 provides direct access to internal HVAC components, such as a vent actuator, positioned within or adjacent to the air inlet housing 206. This configuration enables service or replacement of the vent actuator by reaching through the air inlet opening, for example, once the front lid is opened and the air filter is removed, as described in the subsequent figures.

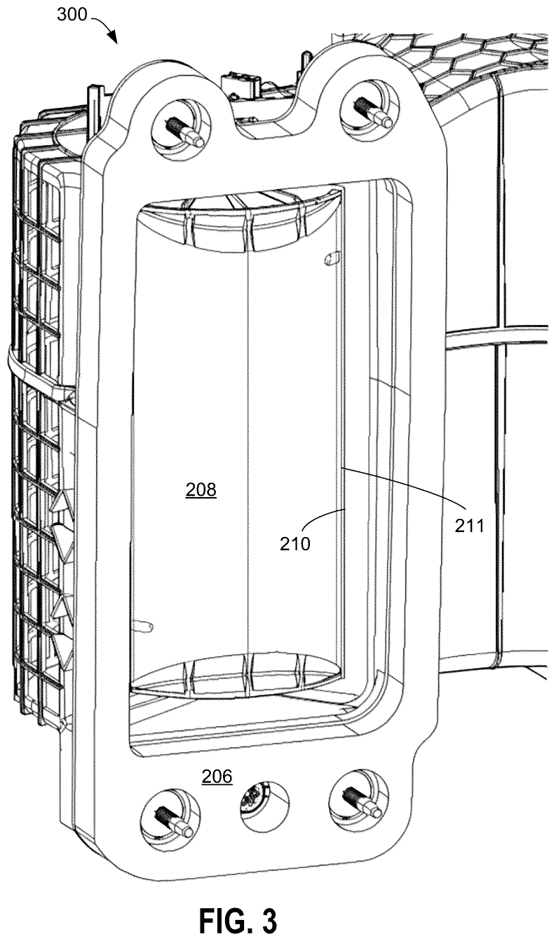

FIG. 3 shows a view of an HVAC system 300 having the air inlet 102 with a recirculation flap 208 in a closed position. In this position, the flap 208 blocks an airflow passage leading to a downstream HVAC duct 230 that forms part of the main HVAC housing 232.

The flap 208 includes a sealing edge 210 extending around at least a perimeter portion of the flap. In the closed position, the sealing edge 210 engages a complementary seat 211 formed along an inner rim of the housing 206 to substantially block airflow through the air inlet 102. The sealing edge 210 may comprise an elastomeric lip, a compressible foam bead, or a co-molded gasket carried by the flap 208; in other embodiments the seat 211 carries the compliant material and the flap edge is rigid. Stops on the housing 206 and/or flap 208 can define end-of-travel positions for repeatable sealing engagement and to prevent over-rotation.

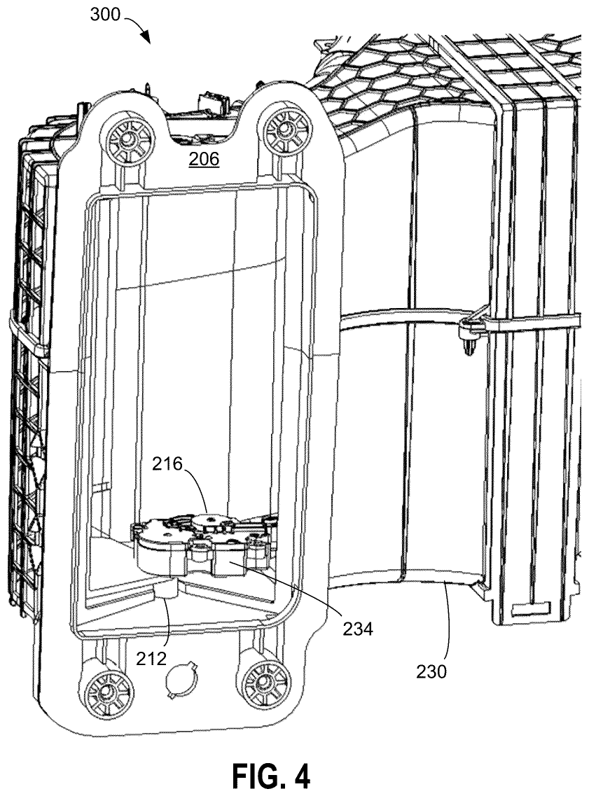

Referring now to FIG. 4, the HVAC system 300 is shown with the recirculation flap 208 in an open position, thereby exposing the vent actuator 216 and rotation shaft 212 that operate the flap. In this configuration, the flap 208 has been rotated away from its sealing seat 211, allowing air to flow freely from the atmosphere through the air inlet 102 and into the downstream duct 230 of the HVAC system 300.

As illustrated, the vent actuator 216 is mounted directly to the air inlet housing 206 and is operatively connected to the rotation shaft 212. The actuator 216 includes a motor housing 234 containing a compact drive motor and gear train that convert electrical control inputs into rotational motion of the shaft 212. The motor housing 234 may be secured to the air inlet housing 206 by a mounting flange 224, which may be fastened using fasteners 226 extending through apertures in the flange and into corresponding threaded inserts or bosses formed in the housing 206. A sealing gasket 220 is positioned between the flange 224 and the housing 206 to prevent air leakage through the actuator interface and to reduce vibration transmission.

The actuator 216 drives the rotation shaft 212 through a drive coupling 222, which may be of a keyed or splined configuration to provide positive torque transmission and precise positioning of the flap 208. In some embodiments, the coupling 222 may include a D-flat interface or a polygonal bore that mates with a corresponding shape on the rotation shaft 212. The rotation shaft 212 extends transversely across the housing 206 and supports the flap 208, enabling it to selectively pivot between the open and closed positions under control of the actuator 216. The ends of the shaft 212 may be received in bearings, for example, for smooth and low-friction motion during operation.

The actuator 216 may be equipped with an aerodynamic cover 218 or streamlined contour to minimize disturbance to the airflow entering the air inlet 102. The actuator's external profile may be shaped to conform to adjacent surfaces of the air inlet housing 206, reducing packaging space while maintaining an unobstructed airflow path. In some versions, the actuator 216 is retained by snap-fit connectors, such as integral snap-fit connectors, rather than mechanical fasteners 226, allowing tool-less removal and installation for quick service access.

The configuration shown in FIG. 4 allows the actuator 216 and the shaft 212 to be directly visible and accessible once the air filter 204 is removed from the air inlet 102. A technician can remove and replace the actuator 216 by opening the front lid 104, removing the filter 204, and reaching the actuator through the air inlet opening. The actuator 216 can then be detached from the housing 206, disconnected from the rotation shaft 212, and replaced with a new unit.

In operation, the actuator 216 rotates the flap 208 between the fresh-air and recirculation positions to control the source of air supplied to the cabin. The structural arrangement shown in FIG. 4, where the actuator 216 is positioned within the air inlet 102 and mounted directly to the housing 206 on the rotation shaft 212, provides reliable operation, simplified serviceability, and reduced interior disassembly compared with conventional HVAC configurations.

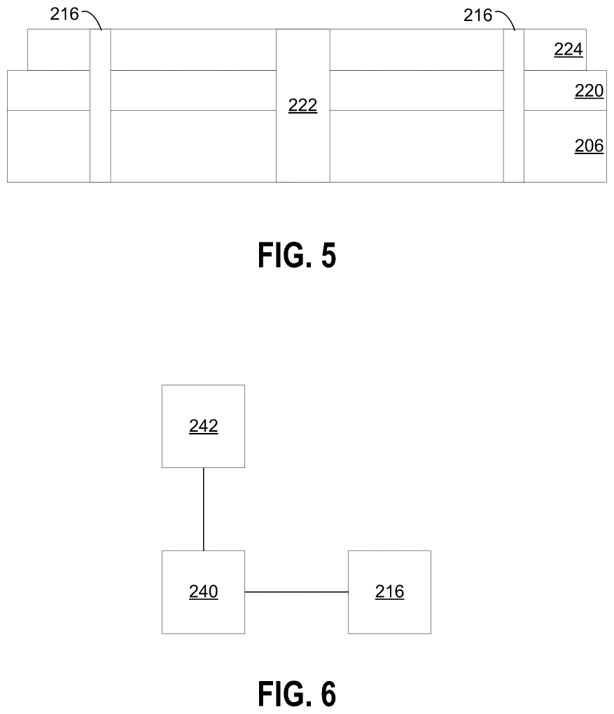

Referring to FIG. 5, a schematic representation of the actuator mounting interface is shown. The actuator includes a mounting flange 224 secured to the air inlet housing 206 by fasteners 226. A sealing gasket 220 is positioned between the flange 224 and the housing 206 to provide an airtight seal. A drive coupling 222 extends through the interface and engages the rotation shaft 212 to transmit torque from the actuator motor to the recirculation flap 208.

Referring now to FIG. 6, a block diagram of a control system for operating the vent actuator 216 is shown. The system includes an HVAC control unit 240, a sensor 242, and the actuator 216 described previously. The HVAC control unit 240 is configured to generate electrical control signals that determine the position of the recirculation flap 208. The control unit 240 may include one or more microcontrollers, memory devices, and drive circuits for controlling the operation of multiple actuators within the HVAC system, including mode, blend, and vent actuators.

The sensor 242 provides an input signal to the HVAC control unit 240 that is indicative of an environmental or cabin condition. In some embodiments, the sensor 242 is an air quality sensor that detects parameters such as carbon dioxide concentration, particulate level, or the presence of external pollutants. In other embodiments, the sensor 242 may be a temperature, humidity, or pressure sensor located within the vehicle cabin or at the fresh-air inlet. The HVAC control unit 240 processes the signal from the sensor 242 and determines whether to operate the actuator 216 to move the flap 208 to a recirculation or fresh-air position.

The actuator 216 receives the control signal from the HVAC control unit 240 via an electrical connector or vehicle communication bus and responds by rotating the rotation shaft 212 to position the flap 208 accordingly. The actuator 216 may include an internal position sensor or feedback circuit to report its angular position back to the HVAC control unit 240, allowing closed-loop control of flap position.

In operation, the arrangement shown in FIG. 6 allows the HVAC system to automatically regulate the source of intake air based on sensed cabin or ambient conditions. For example, if the sensor 242 detects poor air quality outside the vehicle, the HVAC control unit 240 commands the actuator 216 to close the fresh-air path and move the flap 208 to the recirculation position, thereby maintaining cleaner air inside the vehicle cabin.

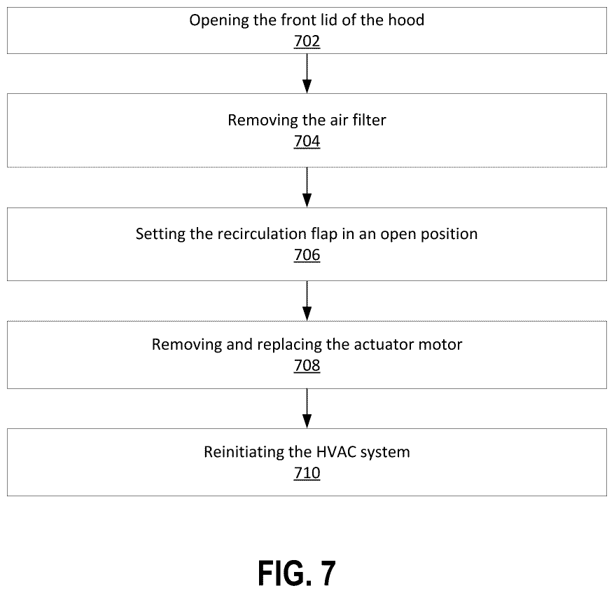

Referring now to FIG. 7, a flow diagram illustrates a method 700 for replacing a vent actuator, such as a recirculation actuator, in a vehicle heating, ventilation, and air-conditioning (HVAC) system. The method enables the actuator to be accessed and replaced by reaching through an air inlet opening, e.g., once the front lid is opened and the air filter is removed, thereby simplifying service procedures and reducing disassembly of interior components.

At step 702, the method includes opening a front lid of the vehicle hood to expose the HVAC air inlet region. In some vehicle configurations, the air inlet 102 is located on the backside of the HVAC assembly facing the front of the vehicle, so opening the front lid 104 provides direct exterior access to this area.

At step 704, the method includes removing an air filter 204 from the air inlet 102. The air filter 204 is typically positioned behind an intake grille 202 within the air inlet housing 206 and is secured by clips or a frame that can be released without tools. Removal of the air filter provides a clear access opening into the air inlet 102, exposing the internal components of the HVAC system, including the recirculation flap 208 and actuator 216.

At step 706, the method includes setting the recirculation flap in an open position. This can be accomplished, for example, by commanding the actuator 216 through the HVAC control unit 240 to move the flap 208 to its open or fresh-air position. Moving the flap 208 to the open position may be useful, for example, so that the actuator 216 and the rotation shaft 212 are unobstructed and accessible through the air inlet opening.

In some service situations, the recirculation flap 208 may initially be in a closed position due to an electrical failure or mechanical jam of the actuator 216. When the actuator malfunctions in this state, it may prevent the flap from moving under normal control signals from the HVAC control unit 240, thereby blocking access to the actuator through the air inlet 102. To address this, the technician may manually position the flap 208 in the open position by partially disengaging the actuator drive coupling 222, applying manual torque to the rotation shaft 212, or using a service access tool designed to release or rotate the flap linkage. In certain embodiments, the actuator 216 may include a manual override feature, such as a hex drive or lever, that allows the flap 208 to be moved mechanically even when the actuator motor is non-functional. This may be useful, for example, so that the actuator can still be reached and replaced through the air inlet opening without requiring disassembly of interior components or removal of the HVAC housing.

In some embodiments, the HVAC control unit 240 is configured to detect an actuator malfunction based on feedback from the actuator 216 or from position and current-sensing data. For example, if the control unit 240 commands movement of the recirculation flap 208 but does not receive a corresponding position change signal or observes an overcurrent condition from the actuator 216, the system may log a diagnostic trouble code indicating an actuator fault or flap obstruction. In vehicles equipped with an air quality or cabin environment sensor 242, the control unit 240 may also infer a failure if the expected change in airflow mode or air composition does not occur after a flap movement command. This diagnostic capability assists the technician in identifying when the flap 208 is stuck in a closed position and allows targeted servicing of the actuator 216. During replacement, the technician may clear the fault code after reinitialization at step 710 to restore normal control and communication between the actuator 216 and the HVAC control unit 240.

At step 708, the method includes removing and replacing the actuator motor. The actuator 216 may be mounted to the air inlet housing 206 by fasteners 226 or by snap-fit connectors. A technician can reach the actuator 216 through the air inlet opening and detach the fasteners or clips securing the mounting flange 224. The actuator 216 is then disconnected from the rotation shaft 212, which may use a keyed or splined drive coupling 222. A replacement actuator is subsequently installed by aligning its drive coupling with the rotation shaft 212, positioning its flange 224 against the housing 206 with a sealing gasket 220 therebetween, and securing it using the fasteners 226. This entire operation can be performed externally, without removing the dashboard or disassembling interior panels.

At step 710, the method includes reinitializing the HVAC system. After installation, the actuator 216 may require calibration or synchronization with the HVAC control unit 240. Reinitialization may include turning the vehicle ignition on, executing a control module reset, or commanding the actuator to perform a full-range sweep to learn end positions. This may be useful, for example, so that the actuator 216 properly responds to control signals from the HVAC control unit 240 and that the recirculation flap 208 moves correctly between the fresh-air and recirculation positions.

In certain embodiments, the method 700 further includes diagnostic verification that the actuator 216 is communicating with the HVAC control unit 240 and providing valid position feedback. The method may also include replacing or inspecting the air filter 204 prior to reinstallation and verifying that the air inlet 102 is free of obstructions.

Additional examples include:

Example 1. A method for replacing a vent actuator in a heating, ventilation, and air-conditioning (HVAC) system of a vehicle, the method comprising:
opening a front lid of the vehicle to access an air inlet;
removing an air filter from the air inlet;
removing the vent actuator through the air inlet; and
installing a replacement vent actuator through the air inlet.

Example 2. The method of Example 1, further comprising positioning a flap of the HVAC system in an open position prior to removing the vent actuator.

Example 3. The method of Example 1, wherein the vent actuator is mounted on a rotation shaft of a flap of the HVAC system.

Example 4. The method of Example 3, wherein the flap is a recirculation flap and the vent actuator is a recirculation actuator configured to operate a recirculation flap of the HVAC system, the method comprising rotating, by the recirculation actuator, the rotation shaft to move the recirculation flap between a fresh-air position and a recirculation position.

Example 5. The method of Example 4, comprising receiving, by the vent actuator, an electrical control signal from an HVAC control unit to position the recirculation flap.

Example 6. The method of Example 5, wherein the HVAC control unit generates the control signal in response to a sensor signal indicative of a cabin air quality parameter.

Example 7. The method of Example 4, wherein the recirculation flap is pivotably mounted within the air inlet to selectively block or allow airflow.

Example 8. The method of Example 1, further comprising reinitializing the HVAC system after installation of the replacement vent actuator.

Example 9. The method of Example 1, wherein the replacement vent actuator is installed with a cover.

Example 10. The method of Example 9, wherein the cover is shaped to reduce aerodynamic disturbance of airflow through the air inlet.

Example 11. The method of Example 1, wherein the vent actuator is accessed directly after removal of the air filter without disassembly of interior cabin components.

Example 12. A heating, ventilation, and air-conditioning (HVAC) system for a vehicle, the HVAC system comprising:
an air inlet configured to receive outside air into the HVAC system;
an air filter removably mounted within the air inlet;
a recirculation flap pivotably mounted within the air inlet and rotatable between a fresh-air position and a recirculation position; and
a recirculation actuator positioned within the air inlet and accessible for removal and installation through the air inlet.

Example 13. The HVAC system of Example 12, wherein the recirculation actuator is mounted on a rotation shaft of the recirculation flap.

Example 14. The HVAC system of Example 13, wherein the recirculation actuator comprises a motor housing including a drive coupling directly engaged with the rotation shaft of the recirculation flap.

Example 15. The HVAC system of Example 14, wherein the drive coupling comprises a keyed or splined interface configured to mate a corresponding portion of the rotation shaft.

Example 16. The HVAC system of Example 12, wherein the recirculation actuator is disposed entirely within the air inlet downstream of the air filter.

Example 17. The HVAC system of Example 12, wherein the recirculation actuator is secured to the air inlet by at least one fastener extending through a flange portion of an actuator housing or by snap-fit connectors integrally formed on the actuator housing.

Example 18. The HVAC system of Example 12, wherein the recirculation actuator includes a cover.

Example 19. The HVAC system of Example 18, wherein the cover is shaped to reduce aerodynamic disturbance of airflow through the air inlet.

Example 20. The HVAC system of Example 12, wherein the recirculation flap comprises a sealing edge configured to substantially block airflow when the flap is in a closed position.

The operational steps described in any of the exemplary embodiments herein are described to provide examples and discussion. Although a specific order of method steps may be shown or described, the order of the steps may differ. In addition, two or more steps may be performed concurrently or with partial concurrence.

It is to be understood that the concepts described herein are not limited to the embodiments described above and illustrated in the drawings; rather, the skilled person will recognize that many changes and modifications may be made within the scope of the present disclosure and appended claims.

1. A method for replacing a vent actuator in a heating, ventilation, and air-conditioning (HVAC) system of a vehicle, the method comprising:
opening a front lid of the vehicle to access an air inlet;
removing an air filter from the air inlet;
removing the vent actuator through the air inlet; and
installing a replacement vent actuator through the air inlet.

2. The method of claim 1, further comprising positioning a flap of the HVAC system in an open position prior to removing the vent actuator.

3. The method of claim 1, wherein the vent actuator is mounted on a rotation shaft of a flap of the HVAC system.

4. The method of claim 3, wherein the flap is a recirculation flap and the vent actuator is a recirculation actuator configured to operate a recirculation flap of the HVAC system, the method comprising rotating, by the recirculation actuator, the rotation shaft to move the recirculation flap between a fresh-air position and a recirculation position.

5. The method of claim 4, comprising receiving, by the vent actuator, an electrical control signal from an HVAC control unit to position the recirculation flap.

6. The method of claim 5, wherein the HVAC control unit generates the control signal in response to a sensor signal indicative of a cabin air quality parameter.

7. The method of claim 4, wherein the recirculation flap is pivotably mounted within the air inlet to selectively block or allow airflow.

8. The method of claim 1, further comprising reinitializing the HVAC system after installation of the replacement vent actuator.

9. The method of claim 1, wherein the replacement vent actuator is installed with a cover.

10. The method of claim 9, wherein the cover is shaped to reduce aerodynamic disturbance of airflow through the air inlet.

11. The method of claim 1, wherein the vent actuator is accessed directly after removal of the air filter without disassembly of interior cabin components.

12. A heating, ventilation, and air-conditioning (HVAC) system for a vehicle, the HVAC system comprising:
an air inlet configured to receive outside air into the HVAC system;
an air filter removably mounted within the air inlet;
a recirculation flap pivotably mounted within the air inlet and rotatable between a fresh-air position and a recirculation position; and
a recirculation actuator positioned within the air inlet and accessible for removal and installation through the air inlet.

13. The HVAC system of claim 12, wherein the recirculation actuator is mounted on a rotation shaft of the recirculation flap.

14. The HVAC system of claim 13, wherein the recirculation actuator comprises a motor housing including a drive coupling directly engaged with the rotation shaft of the recirculation flap.

15. The HVAC system of claim 14, wherein the drive coupling comprises a keyed or splined interface configured to mate a corresponding portion of the rotation shaft.

16. The HVAC system of claim 12, wherein the recirculation actuator is disposed entirely within the air inlet downstream of the air filter.

17. The HVAC system of claim 12, wherein the recirculation actuator is secured to the air inlet by at least one fastener extending through a flange portion of an actuator housing or by snap-fit connectors integrally formed on the actuator housing.

18. The HVAC system of claim 12, wherein the recirculation actuator includes a cover.

19. The HVAC system of claim 18, wherein the cover is shaped to reduce aerodynamic disturbance of airflow through the air inlet.

20. The HVAC system of claim 12, wherein the recirculation flap comprises a sealing edge configured to substantially block airflow when the flap is in a closed position.
